(19) United States
(12) Patent Application Publication
(10) Pub. No.: US 2019/0042012 A1
(43) Pub. Date: Feb. 7, 2019

(54) SUBSTRATE

(71) Applicant: FUJITSU COMPONENT LIMITED, Tokyo (JP)

(72) Inventors: Ayumu AKABANE, Tokyo (JP); Tsuyoshi KANDA, Tokyo (JP); Shailendra Kumar SHAH, Tokyo (JP); Fumio TAKEI, Tokyo (JP)

(73) Assignee: FUJITSU COMPONENT LIMITED, Tokyo (JP)

(21) Appl. No.: 16/021,711

(22) Filed: Jun. 28, 2018

(30) Foreign Application Priority Data
Aug. 4, 2017 (JP) 2017-151997

(51) Int. Cl. G06F 3/041; G06F 3/01

(52) U.S. Cl. CPC G06F 3/041; G06F 2203/014; G06F 3/016

(57) ABSTRACT

A substrate includes: a plurality of wiring patterns arranged to face each other; an electronic component that is disposed between the wiring patterns and has electrodes at both end portions; and a conductive member that connects the wiring patterns to the electrodes, wherein the wiring patterns have such a shape that a distance between the wiring patterns changes in a region where the electronic component is disposed.

### CROSS-REFERENCE TO RELATED APPLICATION

This application is based upon and claims the benefit of priority of the prior Japanese Patent Application No. 2017-151997 filed on Aug. 4, 2017, the entire contents of which are incorporated herein by reference.

### FIELD

A certain aspect of the embodiments is related to a substrate.

### BACKGROUND

There is a conventionally known tactile sensation transmission apparatus that includes: an input unit that has an input region for detecting an input position; a vibrating body that is provided in a region outside the input unit, includes a power supply terminal, and causes the input unit to vibrate; an external conducting terminal provided in a region outside the input unit; and a connecting wiring line that electrically connects the power supply terminal and the external conducting terminal as disclosed in, for example, Japanese Patent Application Publication No. 2011-113419.

### SUMMARY

According to an aspect of the present invention, there is provided a substrate including: a plurality of wiring patterns arranged to face each other; an electronic component that is disposed between the wiring patterns and has electrodes at both end portions; and a conductive member that connects the wiring patterns to the electrodes, wherein the wiring patterns have such a shape that a distance between the wiring patterns changes in a region where the electronic component is disposed.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a configuration diagram of an information processing apparatus that includes a tactile IF panel;

FIG. 2 is a configuration diagram of the tactile IF panel;

FIG. 3A is a configuration diagram of a piezoelectric element and wiring patterns, and FIG. 3B through FIG. 3F are diagrams illustrating examples of connection between a piezoelectric element and wiring patterns;

FIG. 4A through FIG. 4D are diagrams illustrating example layouts of a piezoelectric element and wiring patterns, FIG. 4E is a cross-sectional view of a tactile IF panel in which piezoelectric elements are electrically connected to wiring patterns via jumper resistors, and FIG. 4F is a diagram illustrating modifications of wiring patterns;

FIG. 5A through FIG. 5D are diagrams illustrating example layouts of a piezoelectric element, wiring patterns, and other patterns, FIG. 5E is a cross-sectional view of a tactile IF panel in which piezoelectric elements are electrically connected to wiring patterns via jumper resistors, and FIG. 5F is a diagram illustrating modifications of wiring patterns and other patterns;

FIG. 6A is a diagram illustrating an example layout of a piezoelectric element and wiring patterns, FIG. 6B is a diagram illustrating modifications of the wiring patterns shown in FIG. 6A, FIG. 6C is a diagram illustrating an example layout of a piezoelectric element, wiring patterns, and other patterns, and FIG. 6D is a diagram illustrating modifications of the wiring patterns and the other patterns shown in FIG. 6C;

FIG. 7A is a diagram illustrating an example layout of a piezoelectric element and wiring patterns, FIG. 7B is a diagram illustrating modifications of the wiring patterns shown in FIG. 7A, FIG. 7C is a diagram illustrating an example layout of a piezoelectric element, wiring patterns, and other patterns, and FIG. 7D is a diagram illustrating modifications of the wiring patterns and the other patterns shown in FIG. 7C; and

FIG. 8A is a diagram illustrating an example layout of a piezoelectric element and wiring patterns, FIG. 8B is a diagram illustrating modifications of the wiring patterns shown in FIG. 8A, FIG. 8C is a diagram illustrating an example layout of a piezoelectric element, wiring patterns, and other patterns, and FIG. 8D is a diagram illustrating modifications of the wiring patterns and the other patterns shown in FIG. 8C.

### DESCRIPTION OF EMBODIMENTS

If electronic components to be mounted between two wiring patterns greatly vary in length in the longitudinal direction, the mounting precision of the electronic components becomes lower, and the electronic components cannot be easily mounted between the two wiring patterns. Particularly, components for surface mounting have appropriate values for distances from the wiring patterns and the like at the time of mounting. If the distances between the components for surface mounting and the wiring patterns do not have appropriate values, the components for surface mounting might move, or a solder cannot be applied, for example.

The following is a description of an embodiment of the present invention, with reference to the accompanying drawings.

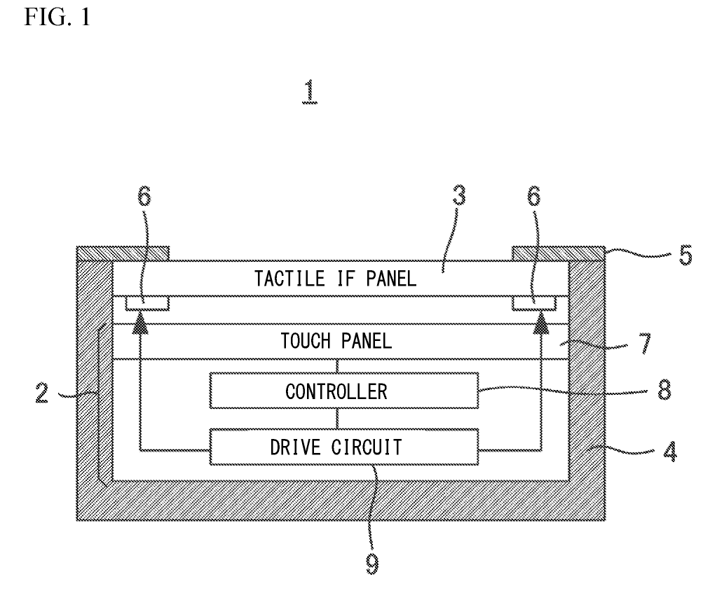

FIG. 1 is a configuration diagram of an information processing apparatus including a tactile IF panel.

The information processing apparatus 1 shown in FIG. 1 includes: an information processing terminal 2 such as a smartphone or a touch-pad; a tactile interface (IF) panel 3 disposed on the information processing terminal 2; a housing 4 that houses the information processing terminal 2 and the tactile IF panel 3; and a cover 5 that covers the outer peripheral portion of the upper surface of the tactile IF panel 3. The tactile IF panel 3 includes piezoelectric elements 6 used as actuators providing tactile sensation to the operator. The information processing terminal 2 includes a touch panel 7, a controller 8, and a drive circuit 9.

When the operator touches the tactile IF panel 3 with his/her finger, the controller 8 detects the touched position via the touch panel 7. The controller 8 then outputs a signal corresponding to the touched position and the moving direction or velocity of the finger that has touched the tactile IF panel 3, to the drive circuit 9. In accordance with the signal received from the controller 8, the drive circuit 9 supplies the piezoelectric elements 6 with a signal designated by the controller 8, to cause the piezoelectric elements 6 to vibrate. Thus, a tactile sensation corresponding to the touched position is provided to the finger of the operator on the tactile IF panel 3.

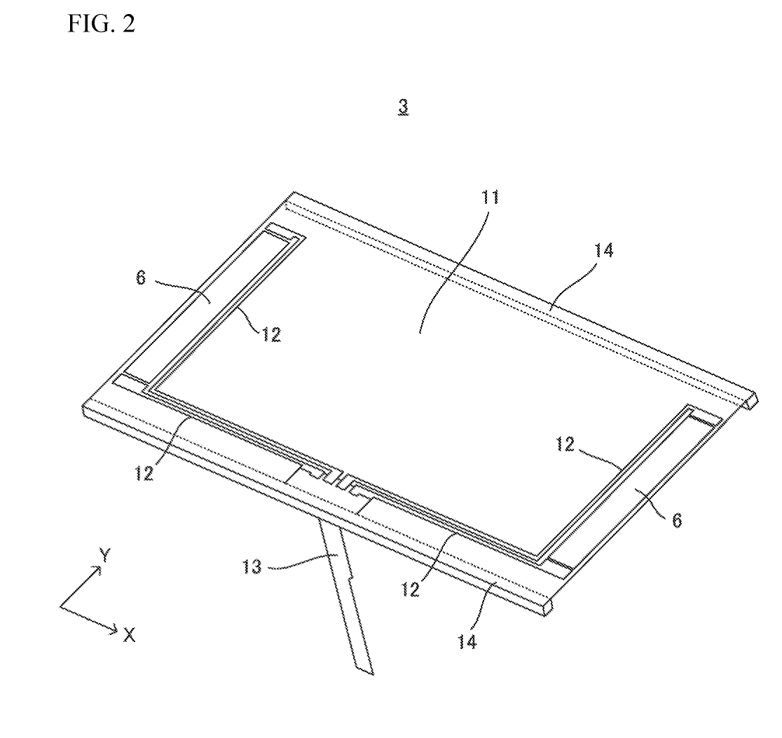

FIG. 2 is a configuration diagram of the tactile IF panel 3.

The tactile IF panel 3 includes: a vibrating panel (hereinafter referred to as the “panel”) 11 formed with a transparent rectangular glass; the piezoelectric elements 6 as electronic components provided at both ends of the panel 11 in the X-direction; wiring patterns 12 formed on the panel 11 in such a manner as to sandwich each piezoelectric element 6 at both ends in the Y-direction; a flexible printed circuit (FPC) 13 connected to one end of each wiring pattern 12; and a base 14 for securing the panel 11 to the housing 4. In a case where an image is to be displayed on the display, the panel 11 is preferably transparent. However, in a case where the tactile IF panel is to be used without the need for any display, the panel 11 is not necessarily transparent. The panel 11 functions as the substrate. The FPC 13 is connected to the drive circuit 9 shown in FIG. 1. The wiring patterns 12 are formed by print firing of silver paste, and the wiring pattern manufacturing technique already used in the touch panel manufacture can also be used here.

Instead of the wiring patterns 12, wires may be used. In a case where wires are used, however, the following problems might be caused: 1) the wires might be cut due to vibration when the wires come into contact with the panel 11, 2) the wires subjected to vibration of the panel 11 might transmit the vibration to the components in the neighborhood when the wires come into contact with the components in the neighborhood, and 3) vibration transmitted from the wires might cause resonance depending on the arrangement of the wires or the components. Therefore, the wiring patterns 12 are used in this embodiment.

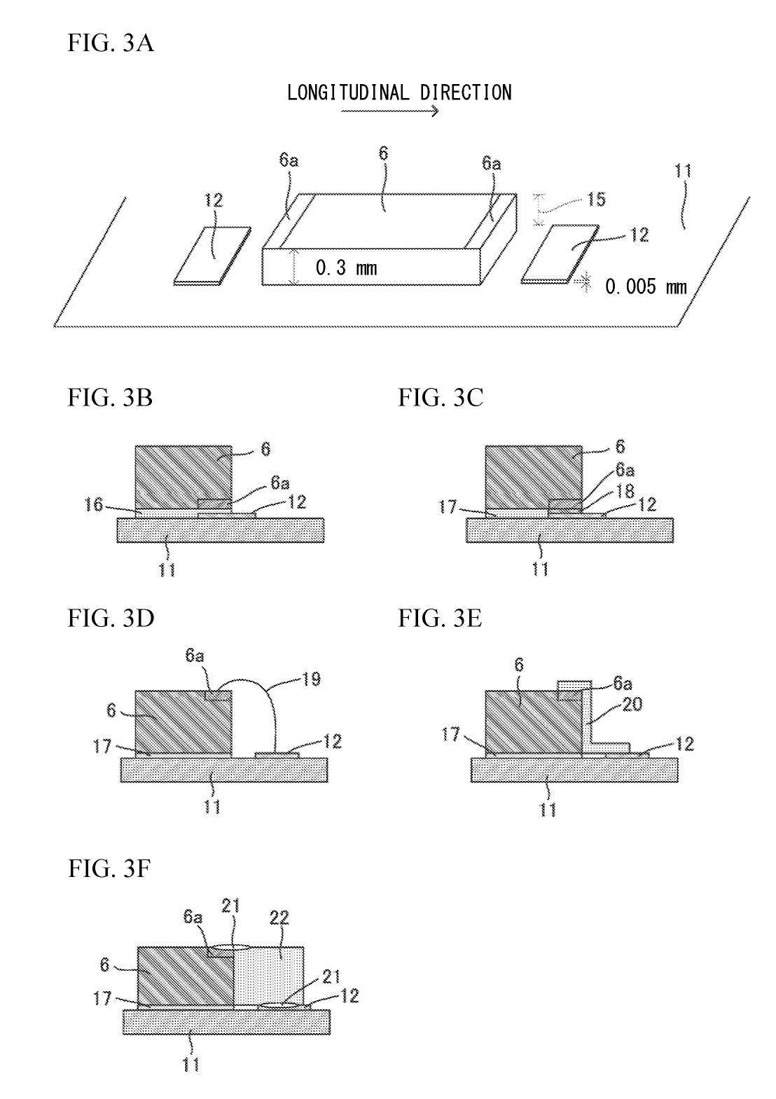

FIG. 3A is a configuration diagram of the piezoelectric element 6 and the wiring patterns 12.

The piezoelectric element 6 has electrodes 6a formed on its upper surface at both ends in the longitudinal direction, and is 0.3 mm in thickness, for example. On the other hand, the thickness of the wiring patterns 12 is 0.005 mm. As the wiring patterns 12 are much thinner than the piezoelectric element 6, there is a step 15 formed between the upper surface of the piezoelectric element 6 on which the electrodes 6a are formed, and the upper surfaces of the wiring patterns 12. To electrically connect the electrodes 6a of the piezoelectric element 6 to the wiring patterns 12, it is necessary to overcome the step 15.

In the description below, methods for overcoming the step 15 are described. FIG. 3B through FIG. 3F show examples of connection between the piezoelectric element 6 and the wiring patterns 12 shown in FIG. 3A.

In FIG. 3B, the piezoelectric element 6 is turned upside down, so that the electrodes 6a face the panel 11. The electrodes 6a of the piezoelectric element 6 are bonded to the wiring patterns 12 with a conductive adhesive 16 like an anisotropic conductive film (ACF). Further, the surface of the piezoelectric element 6 on the side of the panel 11, except for the electrodes 6a, is bonded onto the panel 11 also with the conductive adhesive 16.

In this case, any special components for connecting the piezoelectric element to the wiring patterns 12 are not required, and the electrodes 6a of the piezoelectric element 6 and the surface of the piezoelectric element 6 except for the electrodes 6a can be bonded onto the wiring patterns 12 and the panel 11, respectively, through a single bonding process. However, when a large current (such as a current of 1 A or larger) necessary for driving a piezoelectric element is applied, heat generation increases, because the conductive adhesive 16 has a higher resistance than a solder. Therefore, the conductive adhesive 16 might become unsuitable for the bonding between the electrodes 6a and the wiring patterns 12 in some cases.

In FIG. 3C, the piezoelectric element 6 is also turned upside down, so that the electrodes 6a face the panel 11. The electrodes 6a are bonded to the wiring patterns 12 with a solder 18. Further, the surface of the piezoelectric element 6 except for the electrodes 6a is bonded onto the panel 11 with an adhesive 17.

Any special components for connecting the electrodes 6a to the wiring patterns 12 are not required either in FIG. 3C, but a complicated manufacturing process is required. For example, in a case where the solder 18 is applied to the electrodes 6a prior to the adhesive 17, the position of the piezoelectric element 6 is not easily determined only with the solder 18, and the solder 18 needs to be prevented from flowing into the space between the piezoelectric element 6 and the panel 11 so as to prevent short-circuiting between the electrodes 6a. Alternatively, in a case where the adhesive 17 is applied to the surface of the piezoelectric element 6 prior to the solder 18, it is necessary to provide a masking for preventing the adhesive 17 from flowing into the spaces (which are spaces of 1 mm or smaller in height) between the electrodes 6a and the wiring patterns 12. It is also necessary to remove the masking.

Therefore, in the examples shown in FIG. 3B and FIG. 3C, there are possibilities of problems such as unsuitability for use and a need for a complicated manufacturing process.

In FIG. 3D, the electrodes 6a face upward as in FIG. 3A. The bottom surface of the piezoelectric element 6 is bonded to the panel 11 with the adhesive 17. The electrodes 6a are electrically connected to the wiring patterns 12 via wires 19.

In this case, the length of the wires 19 can be adjusted in accordance with the distance between the electrodes 6a and the wiring patterns 12, and accordingly, greater latitude is given in the size tolerance and the mounting precision of the piezoelectric element 6. However, wires are normally thin, and are not suitable for application of a large current (such as a current of 1 A or larger) or a high voltage (10 to 200 V) required for driving the piezoelectric element 6. Further, a special facility is required for mounting the wires, which might lead to higher production costs.

In FIG. 3E, the electrodes 6a also face upward. The bottom surface of the piezoelectric element 6 is bonded to the panel 11 with the adhesive 17. The electrodes 6a are electrically connected to the wiring patterns 12 via clank-like conductors 20. In this case, the crank-like conductors 20 can be formed with a material or a structure in accordance with the current value or the voltage value, and great latitude is given in the size tolerance and the mounting precision of the piezoelectric element 6. However, components like the crank-like conductors 20 need to be manufactured, which might lead to higher production costs.

Therefore, the examples shown in FIG. 3D and FIG. 3E have the problem of higher production costs or the like.

In FIG. 3F, the electrodes 6a also face upward as in FIG. 3A. The bottom surface of the piezoelectric element 6 is bonded to the panel 11 with the adhesive 17. The lower surface of a jumper resistor 22 as a conductive member is electrically connected to the wiring patterns 12 with a solder 21, and the upper surface of the jumper resistor 22 is electrically connected to the electrode 6a with the solder 21. Thus, the piezoelectric element 6 and the wiring pattern are electrically connected to each other via the jumper resistor 22.

As jumper resistors of various sizes and heights are available on the market these days, it is possible to overcome the step 15 by selecting a jumper resistor of an appropriate size and an appropriate height. In this case, there is no need to manufacture any dedicated component, and the step 15 can be overcome with a product available on the market. Further, a surface mounting technique can be adopted.

In view of the above, the jumper resistors 22 that overcome the step 15 are disposed between the electrodes 6a of the piezoelectric element 6 and the wiring patterns 12 in this embodiment, as shown in FIG. 3F.

The piezoelectric elements 6 vary greatly in length in the longitudinal direction, compared with other general electronic components. Therefore, even if the mounting precision and the size precision of the peripheral components are high, the connecting points between the piezoelectric elements 6 and the jumper resistors 22, or the connecting points between the jumper resistors 22 and the wiring patterns 12 vary. This is the same in a case where the electrodes 6a of the piezoelectric elements 6 are connected to the wiring patterns 12 without the use of any jumper resistor 22. Particularly, in the surface mounting of the piezoelectric elements 6, there are appropriate distances between the wiring patterns 12 for each size (each length in the longitudinal direction) of the piezoelectric elements 6. Therefore, if the sizes of the piezoelectric elements 6 are not appropriate ones, problems such as shifting of the jumper resistors 22 or disabling of application of solders are caused. In view of this, measures need to be taken to reduce variation of the lengths of the piezoelectric elements 6 in the longitudinal direction.

In the description below, measures against variation of the lengths of the piezoelectric elements 6 in the longitudinal direction are described.

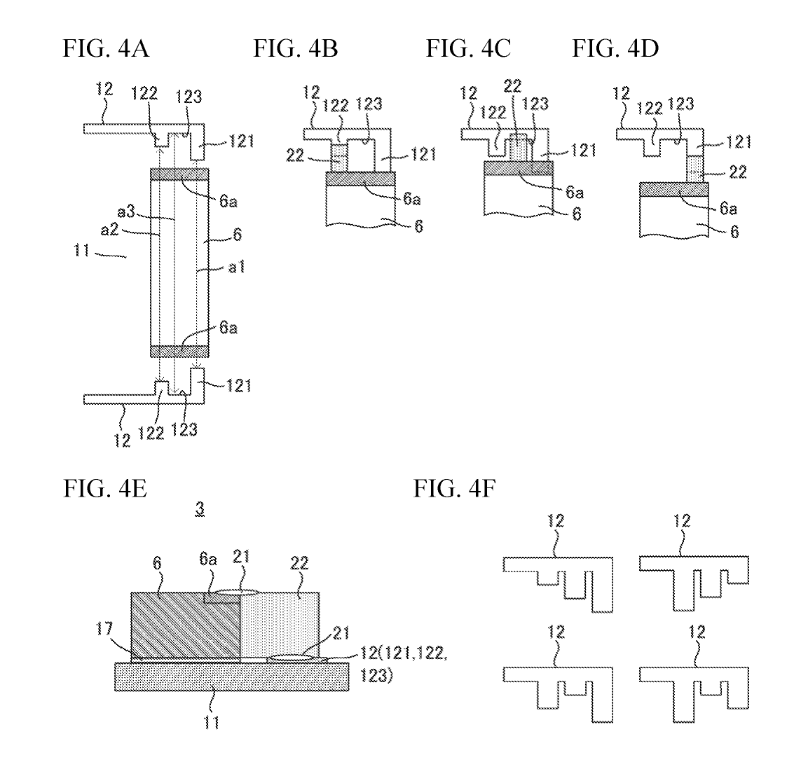

FIG. 4A is a diagram illustrating an example layout of the piezoelectric element 6 and the wiring patterns 12. FIG. 4B is a diagram illustrating the positional relationship among the piezoelectric element 6, the jumper resistor 22, and the wiring pattern 12 in a case where the length of the piezoelectric element 6 in the longitudinal direction is a predetermined length. FIG. 4C is a diagram illustrating the positional relationship among the piezoelectric element 6, the jumper resistor 22, and the wiring pattern 12 in a case where the piezoelectric element 6 is longer than the predetermined length. FIG. 4D is a diagram illustrating the positional relationship among the piezoelectric element 6, the jumper resistor 22, and the wiring pattern 12 in a case where the piezoelectric element 6 is shorter than the predetermined length. FIG. 4E is a cross-sectional view of the tactile IF panel 3 in which the piezoelectric elements 6 are electrically connected to the wiring patterns 12 via the jumper resistors 22. FIG. 4F is a diagram illustrating modifications of the wiring patterns 12.

As shown in FIG. 4A, a pair of the wiring patterns 12 are provided to sandwich the piezoelectric element 6, and the end portions of the wiring patterns 12 facing the end surfaces of the piezoelectric element 6 having the electrodes 6a formed thereon each include protruding portions 121 through 123 that protrude toward the piezoelectric element 6. The protruding amounts of the respective protruding portions 121 through 123 differ from one another. The length of the protrusions of the protruding portions 123 is 0. The protruding portions 122 are longer than the protruding portions 123, and the distance a2 between the protruding portions 122 facing each other is shorter than the distance a3 between the protruding portions 123 facing each other. The protruding portions 121 are even longer than the protruding portions 122, and the distance a1 between the protruding portions 121 facing each other is shorter than the distance a2 between the protruding portions 122 facing each other. With this arrangement, the distance between the wiring patterns 12 facing each other can be made to vary with the positions of the protrusions 121 through 123.

In a case where the piezoelectric element 6 has a predetermined length or has the same length as a standard length, for example, the electrodes 6a are connected to the protruding portions 122 by the jumper resistors 22, as shown in FIG. 4B. As shown in FIG. 4E, the lower surfaces of the jumper resistors 22 are secured onto the protruding portions 122 with the solders 21, and the upper surfaces of the jumper resistors 22 are secured to the electrodes 6a with the solders 21.

In a case where the piezoelectric element 6 is longer than the predetermined length, for example, the electrodes 6a are connected to the protruding portions 123, which have a longer distance between the respective protrusions, via the jumper resistors 22, as shown in FIG. 4C. As shown in FIG. 4E, the lower surfaces of the jumper resistors 22 are secured onto the protruding portions 123 with the solders 21, and the upper surfaces of the jumper resistors 22 are secured to the electrodes 6a with the solders 21.

In a case where the piezoelectric element 6 is shorter than the predetermined length, for example, the electrodes 6a are connected to the protruding portions 121, which have a shorter distance between the respective protrusions, via the jumper resistors 22, as shown in FIG. 4D. As shown in FIG. 4E, the lower surfaces of the jumper resistors 22 are secured onto the protruding portions 121 with the solders 21, and the upper surfaces of the jumper resistors 22 are secured to the electrodes 6a with the solders 21.

As the protrusions 121 through 123 with different lengths are formed at the end portions of the wiring patterns 12 in this manner, the protruding portions to which the piezoelectric element 6 is connected can be changed among the protruding portions 121 through 123 in accordance with the length of the piezoelectric element 6, so that the distances between the piezoelectric element 6 and the wiring patterns 12 can be appropriately set. Thus, it becomes possible to cope with the variation of the lengths of the piezoelectric elements 6 in the longitudinal direction, and the required mounting precision can be lowered. Further, the line widths of the respective protruding portions of the wiring patterns 12 can be made constant. It should be noted that, as shown in FIG. 4F, it is possible to change the number, the positions, the lengths, and the like of the protruding portions, as appropriate.

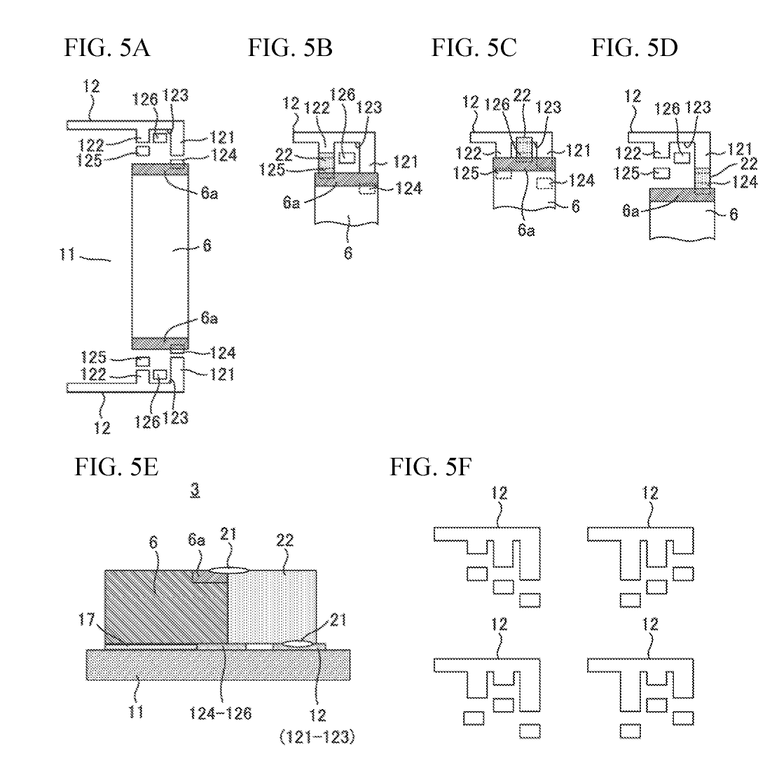

FIG. 5A is a diagram illustrating an example layout of the piezoelectric element 6, the wiring patterns 12, and other patterns. FIG. 5B is a diagram illustrating the positional relationship among the piezoelectric element 6, the jumper resistor 22, the wiring pattern 12, and other patterns in a case where the piezoelectric element 6 has a predetermined length. FIG. 5C is a diagram illustrating the positional relationship among the piezoelectric element 6, the jumper resistor 22, the wiring pattern 12, and other patterns in a case where the piezoelectric element 6 is longer than the predetermined length. FIG. 5D is a diagram illustrating the positional relationship among the piezoelectric element 6, the jumper resistor 22, the wiring pattern 12, and other patterns in a case where the piezoelectric element 6 is shorter than the predetermined length. FIG. 5E is a cross-sectional view of the tactile IF panel 3 in which the piezoelectric elements 6 are electrically connected to the wiring patterns 12 via the jumper resistors 22. FIG. 5F is a diagram illustrating modifications of the wiring patterns 12 and the other patterns.

In FIG. 5A through FIG. 5F, other patterns 124 through 126 are formed on the panel 11. The configurations and the layouts of the piezoelectric elements 6, the wiring patterns 12, and the jumper resistors 22 in FIG. 5A through FIG. 5F are the same as the configurations and the layouts of the piezoelectric elements 6, the wiring patterns 12, and the jumper resistors 22 in FIG. 4A through FIG. 4F, and therefore, explanation of them is not made herein.

It should be noted that, with the configurations and the layouts of the piezoelectric elements 6, the wiring patterns 12, and the jumper resistors 22 shown in FIG. 5A through FIG. 5F, it is possible to achieve the same effects as those of the examples shown in FIG. 4A through FIG. 4F.

As shown in FIG. 5A through FIG. 5D, the patterns 124 through 126 compliant with recommended patterns for the jumper resistors 22 are formed at positions at a predetermined distance from the protruding portions 121 through 123 toward the piezoelectric element 6 on the panel 11. The distance is determined in accordance with the length of each jumper resistor 22 as appropriate. The patterns 124 through 126 are formed by print firing of silver paste at the same time as the wiring patterns 12. The thickness of the patterns 124 through 126 is the same as the thickness of the wiring patterns 12, and is 0.005 mm, for example. As shown in FIG. 5E, part of the lower surface of each jumper resistor 22 is disposed on at least one of the patterns 124 through 126, part of the remaining lower surface of the jumper resistor 22 is secured onto one of the protruding portions 121 through 123 with the solder 21, and the upper surface of each jumper resistor 22 is secured to the corresponding electrode 6a with the solder 21.

In FIG. 5B, the jumper resistor 22 is mounted on a protruding portion 122 and a pattern 125. In FIG. 5C, the jumper resistor 22 is mounted on a protruding portion 123 and the pattern 126. In FIG. 5D, the jumper resistor 22 is mounted on the protruding portion 121 and the pattern 124.

The patterns 124 through 126 having the same thickness as the protruding portions 121 through 123 are formed at positions at a distance from the protruding portions 121 through 123 toward the piezoelectric elements 6. Thus, both ends of each jumper resistor 22 can be disposed on the protruding portions 121 through 123 and the patterns 124 through 126, and the jumper resistors 22 can be firmly secured to the protruding portions 121 through 123.

Where the patterns 124 through 126 are integrally formed with the protruding portions 121 through 123, respectively, the solders 21 for securing the jumper resistors 22 to the protruding portions 121 through 123 flow to the patterns 124 through 126, and the jumper resistors 22 become movable and cannot be firmly secured. Therefore, the patterns 124 through 126 are at a predetermined distance from the protruding portions 121 through 123, respectively.

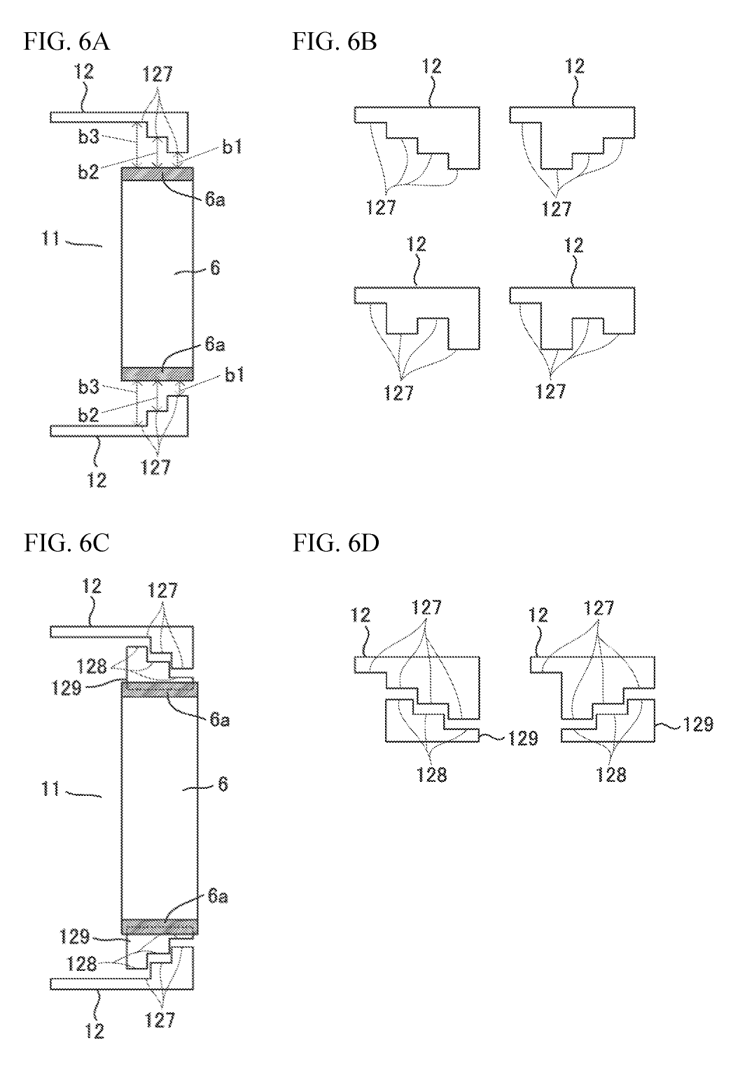

FIG. 6A is a diagram illustrating an example layout of the piezoelectric element 6 and the wiring patterns 12. FIG. 6B is a diagram illustrating modifications of the wiring patterns 12 shown in FIG. 6A. FIG. 6C is a diagram illustrating an example layout of the piezoelectric element 6, the wiring patterns 12, and other patterns. FIG. 6D is a diagram illustrating modifications of the wiring patterns 12 and the other patterns shown in FIG. 6C.

As shown in FIG. 6A, the end portion of each wiring pattern 12 has a protruding portion 127 that protrudes toward the piezoelectric element 6 in a stepwise manner. With this arrangement, distances b1 through b3 are formed between the piezoelectric element 6 and each wiring pattern 12, and the jumper resistor 22 can be connected to a different position on each protruding portion 127 in accordance with the length of the piezoelectric element 6. In a case where the piezoelectric element 6 has a standard length, the jumper resistors 22 are connected to the wiring patterns 12 at the center positions of the protruding portions 127. In a case where the piezoelectric element 6 is long, the distances between the jumper resistors 22 and the wiring patterns 12 are too short at the center positions of the protruding portions 127, and therefore, the jumper resistors 22 are connected to the wiring patterns 12 at the left-side positions in the drawing. In a case where the piezoelectric element is short, on the other hand, the distances between the jumper resistors 22 and the wiring patterns 12 are too long at the center positions of the protruding portions 127, and therefore, the jumper resistors 22 are connected to the wiring patterns 12 at the right-side positions in the drawing. As shown in FIG. 6B, it is possible to change the number of the steps and the positions of the steps of the protruding portions 127 as appropriate.

As shown in FIG. 6C, patterns 129 having protruding portions 128 that face the protruding portions 127 and are at a predetermined distance from the protruding portions 127 protruding in a stepwise manner may be further formed on the panel 11. The distance is set at a length suitable for surface mounting of the jumper resistors 22 as appropriate, in accordance with the length of the jumper resistors 22. The patterns 129 are formed by print firing of silver paste at the same time as the wiring patterns 12. The patterns 129 have the same thickness as the wiring patterns 12. In the case shown in FIG. 6C, the distances between the piezoelectric element 6 and the wiring patterns 12 can be changed in accordance with the length of the piezoelectric element 6, as in FIG. 6A. Further, as the patterns 129 are used, the jumper resistors 22 can be firmly secured as in the examples shown in FIG. 5A through FIG. 5F. As shown in FIG. 6D, it is possible to change the number of the steps and the positions of the steps of the protruding portions 127 and 128 as appropriate.

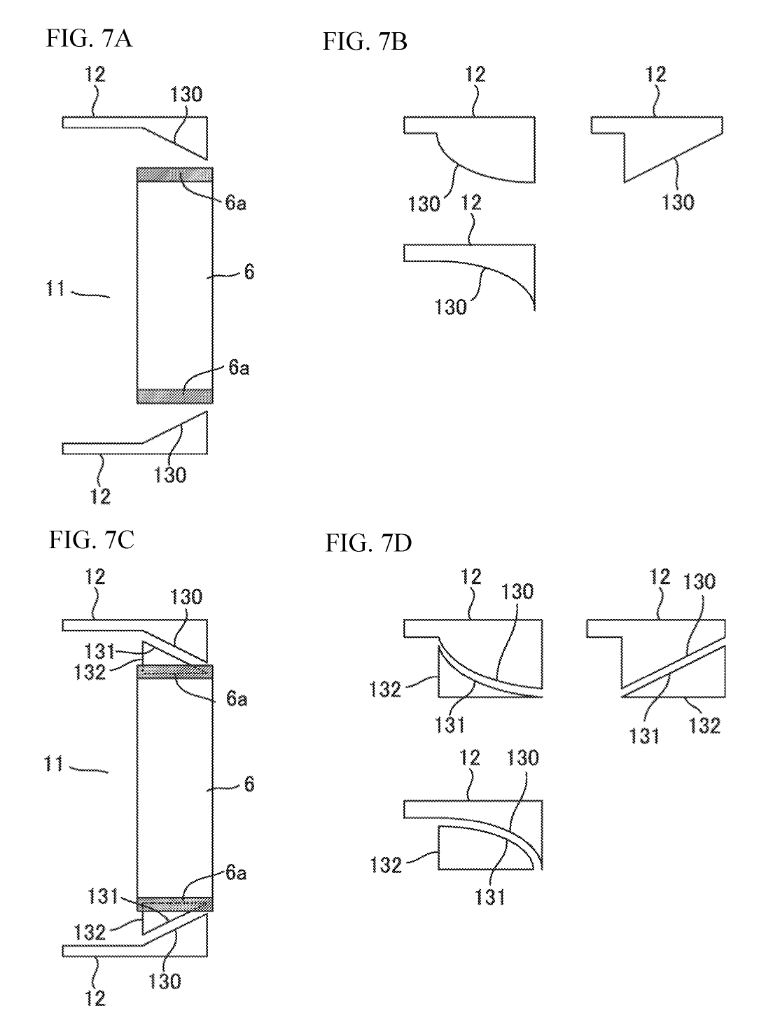

FIG. 7A is a diagram illustrating an example layout of the piezoelectric element 6 and the wiring patterns 12. FIG. 7B is a diagram illustrating modifications of the wiring patterns 12 shown in FIG. 7A. FIG. 7C is a diagram illustrating an example layout of the piezoelectric element 6, the wiring patterns 12, and other patterns. FIG. 7D is a diagram illustrating modifications of the wiring patterns 12 and the other patterns shown in FIG. 7C.

As shown in FIG. 7A, the end portion of each wiring pattern 12 may have a sloped portion 130 that is sloped so as to become closer to the piezoelectric element 6. With this arrangement, the distance between the wiring patterns 12 that face each other continuously changes, and the distances between the piezoelectric element 6 and the wiring patterns 12 can be changed in accordance with the length of the piezoelectric element 6. As the piezoelectric element 6 becomes longer, the jumper resistors 22 are connected to the wiring patterns 12 at positions closer to the left ends of the sloped portions 130 in the drawing. As the piezoelectric element 6 becomes shorter, the jumper resistors 22 are connected to the wiring patterns 12 at positions closer to the right ends of the sloped portions 130 in the drawing. In the cases shown in FIG. 4A and FIG. 6A, the distance between the wiring patterns 12 discretely changes, and therefore, the distances that can be selected are limited. In the case shown in FIG. 7A, however, the distance between the wiring patterns 12 continuously changes, and accordingly, the distances that can be selected are not limited. Further, as shown in FIG. 7B, it is possible to change the angle, the shape, and the like of the sloped portions 130 as appropriate.

As shown in FIG. 7C, patterns 132 each having a sloped portion 131 that faces the corresponding sloped portion 130 and is at a predetermined distance from the corresponding sloped portion 130 may be further formed on the panel 11. The distance is determined as appropriate in accordance with the length of the jumper resistors 22. The patterns 132 are formed by print firing of silver paste at the same time as the wiring patterns 12. The patterns 132 have the same thickness as the wiring patterns 12. In the case shown in FIG. 7C, the distances between the piezoelectric element 6 and the wiring patterns 12 can be changed in accordance with the length of the piezoelectric element 6 as in FIG. 7A. Further, the jumper resistors 22 can be firmed secured. As shown in FIG. 7D, it is possible to change the angles, the shapes, and the like of the sloped portions 130 and 131 as appropriate.

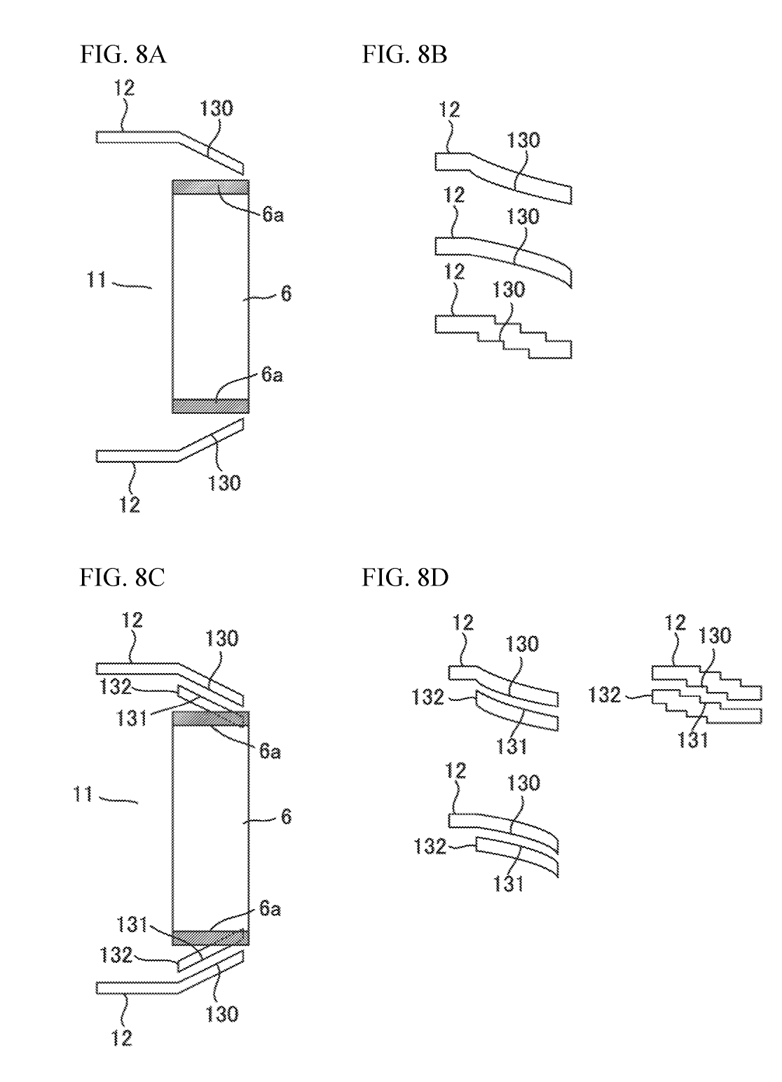

FIG. 8A is a diagram illustrating an example layout of the piezoelectric element 6 and the wiring patterns 12. FIG. 8B is a diagram illustrating modifications of the wiring patterns 12 shown in FIG. 8A. FIG. 8C is a diagram illustrating an example layout of the piezoelectric element 6, the wiring patterns 12, and other patterns. FIG. 8D is a diagram illustrating modifications of the wiring patterns 12 and the other patterns shown in FIG. 8C.

In FIG. 8A, the end portion of each wiring pattern 12 has the sloped portion 130 that is sloped so as to become closer to the piezoelectric element 6, as in FIG. 7A. Accordingly, with the configurations of the piezoelectric element 6 and the wiring patterns 12 shown in FIG. 8A, it is possible to achieve the same effects as those of the configurations shown in FIG. 7A.

In the case shown in FIG. 7A, the width of each wiring pattern 12 gradually increases in the direction toward the right side in the drawing. Therefore, the influence of the expansion/contraction at the time of the firing of the wiring patterns 12 is greater, and the amount of use of the material for the wiring patterns 12 is larger. In the case shown in FIG. 8A, on the other hand, the end portion of each wiring pattern 12 has a constant width. Accordingly, the influence of the expansion/contraction at the time of the firing of the wiring patterns 12 is smaller than in the case shown in FIG. 7A, and the amount of use of the material for the wiring patterns 12 can be reduced. Further, as shown in FIG. 8B, it is possible to change the angle, the shape, and the like of the sloped portions 130 as appropriate.

In FIG. 8C, the patterns 132 each having the sloped portion 131 at a predetermined distance from the corresponding sloped portion 130, as in FIG. 7C. Accordingly, with the configurations of the piezoelectric element 6 and the wiring patterns 12 shown in FIG. 8C, it is possible to achieve the same effects as those of the configurations shown in FIG. 7C.

In the case shown in FIG. 7C, the width of each wiring pattern 12 gradually increases in the direction toward the right side in the drawing, and the width of each pattern 132 gradually increases in the direction toward the left side in the drawing. Therefore, the influence of the expansion/contraction at the time of the firing of the wiring patterns 12 and the patterns 132 is greater, and the amount of use of the material for the wiring patterns 12 and the patterns 132 is larger. In the case shown in FIG. 8C, on the other hand, the end portions of the wiring patterns 12 and the patterns 132 each have a constant width. Accordingly, the influence of the expansion/contraction at the time of the firing of the wiring patterns 12 and the patterns 132 is smaller than in the case shown in FIG. 7C, and the amount of use of the material for the wiring patterns 12 and the patterns 132 can be reduced. Further, as shown in FIG. 8D, it is possible to change the angles, the shapes, and the like of the sloped portions 130 and 131 as appropriate.

As described so far, according to this embodiment, the variation of the distances between the wiring patterns 12 and the piezoelectric elements 6 is eliminated by the end portions of the wiring patterns 12. Thus, even in a case where the piezoelectric elements 6 greatly vary in length, the piezoelectric elements 6 can be easily mounted between the wiring patterns 12.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various change, substitutions, and alterations could be made hereto without departing from the spirit and scope of the invention.

What is claimed is:

1. A substrate comprising:
a plurality of wiring patterns arranged to face each other;
an electronic component that is disposed between the wiring patterns and has electrodes at both end portions; and
a conductive member that connects the wiring patterns to the electrodes,
wherein the wiring patterns have such a shape that a distance between the wiring patterns changes in a region where the electronic component is disposed.

2. The substrate according to claim 1, wherein the wiring patterns each have a protruding portion that protrudes toward the electronic component.

3. The substrate according to claim 2, wherein the protruding portion includes a plurality of protruding portions having protrusions of different sizes.

4. The substrate according to claim 2, wherein the protruding portion protrudes toward the electronic component in a stepwise manner.

5. The substrate according to claim 1, wherein the wiring patterns each includes a sloped portion that is sloped to become gradually closer to the electronic component.

6. The substrate according to claim 1, further comprising a pattern that faces an end portion of each wiring pattern and is at a distance from the end portion.

7. The substrate according to claim 1, wherein the electronic component is a piezoelectric element, and the conductive member is a jumper resistor.

8. A tactile sensation transmission apparatus comprising:
a touch panel unit;
a tactile panel provided over the touch panel unit; and
a driver for driving the tactile panel;
wherein the tactile panel includes:
a panel,
an actuator provided on the panel and configured to provide a tactile sensation,
wiring patterns arranged on a surface of the panel so as to face each other, each of the wiring patterns being connected to corresponding one of electrodes of the actuator disposed between the wiring patterns, and
a conductive member that connects the wiring patterns to the electrodes,
wherein the wiring patterns have such a shape that a distance between the wiring patterns facing each other changes in a region where the actuator is disposed.
